(19) United States
(12) Patent Application Publication
(10) Pub. No.: US 2022/0064022 A1
(43) Pub. Date: Mar. 3, 2022

(54) UTILIZING WASTE HEAT FOR THERMAL DESALINATION

(71) Applicant: SAUDI ARABIAN OIL COMPANY, Dhahran (SA)

(72) Inventors: Ali Homoud Hassan Alshehri, Dhahran (SA); Mohammad Ahmed Alsuwailmi, Ras Tanura (SA); Abdullah A. Alraddadi, Dhahran (SA); Basmah Hasan Hassan Al-Ahmadi, Dhahran (SA); Ahmed Hussain Al-Eid, Dhahran (SA); Nasser Sarhan Albishi, Dhahran (SA)

(73) Assignee: SAUDI ARABIAN OIL COMPANY, Dhahran (SA)

(21) Appl. No.: 17/005,774

(22) Filed: Aug. 28, 2020

(51) Int. Cl. C02F 1/16

(52) U.S. Cl. CPC C02F 1/16; C02F 2103/08

(57) ABSTRACT

A system for desalination of salt water, the system including a crude oil refinery or hydrocarbon refinery, the crude oil refinery or hydrocarbon refinery including a furnace operable to produce a hot flue gas. The furnace including a radiant section, a convection section located above the radiant section, a flue gas stack located above the convection section, a heating coil located in a flow path of a flue gas in the flue gas stack such that the flue gas is capable of increasing a temperature of a water stream, thereby converting at least a portion of the water into steam, and a multi effect desalination plant configured for using the steam to produce a desalinated water.

### BACKGROUND

Desalination is the process of separating pure water from a solution of water and ions, for example where dissolved salts in salt water, such as sea water, are removed. There are many technologies which are well known and used in water desalination, such as, multi-stage flashing (MSF), reverse osmosis (RO), multiple effect distillation (MED), vapor compression (VC), and others.

MED technologies can be used for large-scale water production. The daily production of an MED plant can achieve up to one million cubic meters of desalinated water per day Like power generation, water desalination plants usually depend on burning fossil fuel resources, such as, natural gas, oil, and coal in order to drive the heating and separation processes. Such plants usually implement rotating machinery in order to convert the thermal energy obtained from the combustion of hydrocarbons to mechanical energy, and then convert the energy again into electrical energy using a generator. The electricity is then used to heat the water for the MED plant.

Several other methods are known for generating heat or electricity as the driving energy for MED. Such methods are described below.

### IN4345/DEL/2015: System & Method for Sea Water Desalination by Waste Heat Recovery From Flue Gas

As disclosed in this reference, the major external heat source is taken from a fossil fired plant. This disclosure uses heat exchangers which are added outside of the flue gas stack to produce hot water. In this case, the design is considered to use sensible heat which is related to changing the temperature of the flow and not the phase. Accordingly, the exhaust flue gas removed from the stack is used to produce only hot water, and not change the phase of the water. The hot water is then passed directly to a Multi Effect Desalination (MED) plant which will the produced steam directly through MED to start producing desalinated water.

### CN105253939: High-Temperature Sulfur-Containing Nitrogen-Containing Flue Gas Waste Heat Type Multi-Effect Distillation Seawater Desalination System

This invention consists of more than six major equipment (economizer, electrical denitration, anti-corrosion heat exchanger, flash tank, gas liquid separator) that need to be connected between the source of the flue gas, which is called sulfur-containing nitrogen-containing flue gas, and the Multi Effect Desalination.

This invention has an economizer that works to exchange the heat between the recirculating water and the exhaust of sulfur-containing nitrogen-containing flue gas in order to rise the temperature of liquid flow to certain point but the phase does not change.

### CN106587238: Sea Water Desalination System and Method with Low Temperature Exhaust Heat Utilization Function

This invention tends to use steam generator in order to exchange the heat between the hot source, particularly the refinery process and the recycled distilled water. A steam generator is used to covert the water into a steam without boiling at super-critical pressures.

This invention extracts the hot gas from the refinery process by a pipeline and feeds the hot gas to the steam generator. This invention takes the produced steam from the steam chamber and feeds the steam directly to the P^{t} effect evaporator of MED system.

### NPL: Utilization of Waste Heat from a Flue Gases Up-Stream Gas Scrubbing System (J. Cohen, I. Janovich, A. Muginstein, Engineering Division, Israel Electric Corporation, Ltd., Deaslination 139, 2001, 1-6)

This invention uses a gas cooler which is an additional equipment that is used to produce hot water.

Process-wise, this disclosure tends to necessarily use an air heater due to air pollution requirement.

This disclosure, in alternative B, has two additional pieces of equipment that are used to regulate the flow of the fluid which mainly causes the process to be more complicated in terms of monitoring.

In terms of potential capacity of water production from the desalination, this invention was estimated to produce almost 385.45 (m³/hour) or 9250 (m³/day) at (150° C.) at a cost of 0.55$/m³ in alternative A and 0.5$/main alternative B.

### NPL: A Novel Study of Using Oil Refinery Plants Waste Gases for Thermal Desalination and Electric Power Generation: Enemy, Exergy & Cost Evaluation (M. Eldean, A. M. Soliman, Applied Enemy 195, 2017, 453-477)

This invention has three scenarios for utilizing the waste gases from an oil refinery for a desalination process. This invention intends to use a steam generator in which the waste gas is introduced inside the generator to make the combustion occur. Thus, the heat is being utilized due to the combustion, not the heat of gas itself.

One of the deficiencies of the prior art methods is the heat released from the stack is not fully recovered.

Another method is called combined heat and power or cogeneration. This method utilizes the heat released from the stack to covert the water into steam. Then, the steam flows through the installed turbine to produce the electricity. The disadvantage of this method is that the capital costs are relatively high. Thus, it often tends to outweigh any economic benefits realized by that heat recovery strategy.

### SUMMARY

Embodiments herein are directed toward a system for desalination of salt water, the system including a crude oil refinery or hydrocarbon refinery, the crude oil refinery or hydrocarbon refinery including a furnace operable to produce a hot flue gas. The furnace including a radiant section, a convection section located above the radiant section, a flue gas stack located above the convection section, a heating coil located in a flow path of a flue gas in the flue gas stack such that the flue gas is capable of increasing a temperature of a water stream, thereby converting at least a portion of the water into steam, and a multi effect desalination plant configured for using the steam to produce a desalinated water.

In one aspect, embodiments disclosed herein relate to a method for desalination of salt water, the method including producing a hot flue gas in a furnace of a crude oil refinery or hydrocarbon refinery. The furnace includes a radiant section, a convention section located above the radiant section, a flue gas stack located above the convection section, feeding a water stream to a heating coil located in a path of the hot flue gas in the flue gas stack, heating the water stream using the hot flue gas and converting at least a portion of the water to a steam stream, and feeding the steam stream to a multi effect desalination plant to produce a desalinated water.

Other aspects and advantages will be apparent from the following description and the appended claims.

### BRIEF DESCRIPTION OF DRAWINGS

FIG. 1 is an illustration of an integrated refinery furnace and multi-effect desalination plant according to embodiments disclosed herein.

### DETAILED DESCRIPTION

A significant amount of heat is lost every day from refineries furnaces, which contribute to thermal pollution and climate change. This waste heat can be converted and utilized to generate the thermal energy needed to run a water desalination system, thus it can save a lot of money in the process.

A refinery furnace, or fired heater, is a major component in refineries. Such a furnace can heat the crude oil up to a temperature around 390-400° C. before entering a fractionating column or other such distillation column. The furnace may have a convection section, a radiation chamber, one or more burners, a plurality of tubes, and a flue gas stack. The stack is the upper part where flue gases are exhausted to the outside air. The stack releases a large amount of excess heat without much benefit. On the other hand, Multi-Effect Desalination (MED) Plants are used in crude oil refineries or hydrocarbon refineries to produce drinkable and utility-ready water required to support refinery operation.

MED processes are energy intensive processes and normally utilize boilers to provide the heating requirement to operate the MED evaporators. MED processes depend largely on steam to heat and vaporize the salt water in desalination chambers, or evaporators. For large-scale thermal desalination with MED, an incremental vacuum in the chambers is needed, as the temperature generally drops in the middle and latest chambers of the system. A vacuum enables these systems to eliminate a high boiling point and forces flashing to take place, which reduces the risk of corrosion in the system (the risk of corrosion brought about because sea water has a high total dissolved solids (TDS) count at greater than about 40,000 ppm).

Certain assumptions for steam temperatures, pressures, and flow rates to be used for MED vary significantly, and depend on the plant capacity and location parameters. For example, MED processes may use low pressure steam supplied at 120° C. and 2 bar at 330 ton/hr, or medium pressure steam may be supplied at 230° C. and 18 bar at 10 ton/hr.

Such MED plants may have a capacity in a range of about 50,000 m³/day to about 100,000 m³/day, such as about 70,000 m³/day of desalinated water. As the amount of desalinated water produced and transported is a large quantity, in one embodiment about 70,000 m³/day, in order to determine the necessary steam flow and electricity for the pump station, one would need to consider the geographical situation and specific distance between the locations where the desalinated water is produced and where it used or stored. However, as a generalization, systems and methods disclosed herein can be utilized such that the refinery furnace waste gas may supply the thermal energy requirement of the large-scale MED plant. This may be accomplished by closed-loop coupling the condensate from the MED plant boiler to the refinery furnace. A coiled tube may be placed directly in the flow path of the refinery exhaust gases in order to heat the condensate and covert the condensate to steam, which is fed back to the MED plant boiler as the thermal energy source for desalination.

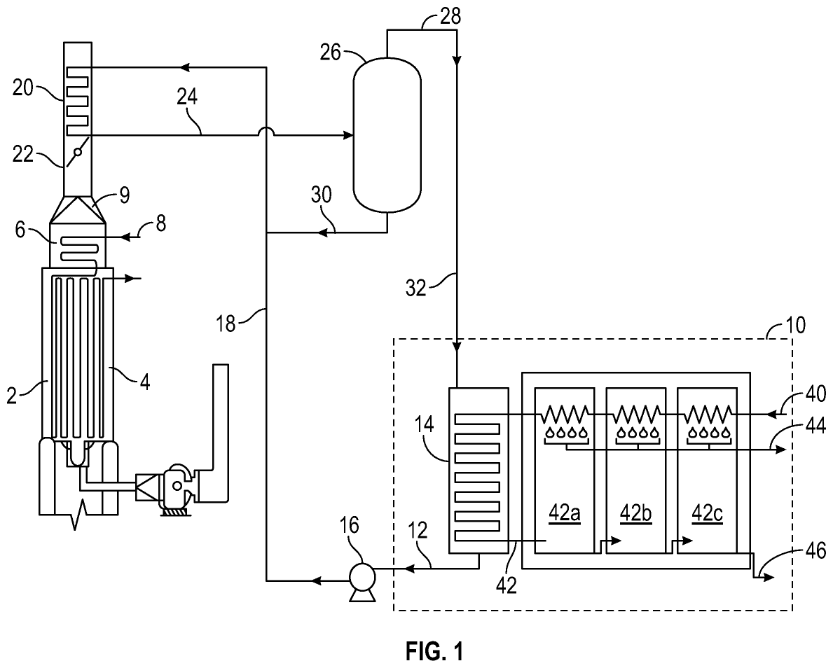

Referring to FIG. 1, in one or more embodiments, the refinery furnace 2 may have a fired, radiant section 4 located proximately the bottom of the furnace 2. The refinery furnace may have a convection section 6 located above the radiant section, where the convection section may receive exhaust from and be heated by the fired, radiant section below. The convection section 6 may have one or more refinery process stream 8 being fed through the convection section. The upper portion of the convection section 6 may have a flow restrictor, or breech, 9, which allows for the radiant section and convection section to be operated at a desired pressure, such as a pressure above an ambient pressure. The refinery furnace may then have an exhaust gas stack 22 located above the flow restrictor 9 and convection section 6, the exhaust gas stack 22 acting as a cooling tower, lowering the temperature of the exhaust gases before they are ejected to atmosphere. The difference between the radiant and convection sections and the exhaust gas stack is that the thermal energy in the exhaust gas stack is insufficient for thermal cracking of hydrocarbons, super heating steam, or other typical refinery operations conducted within the convection section 8 and radiant section 4.

As noted above, the prior art process of using waste heat to power an MED process all have shortcomings which make them less than ideal for efficiently, and cleanly, generating desalinated water.

For example, as disclosed in IN4345/DEL/2015, the flue gas is removed from the convection section and fed to a separate heat exchanger. This necessarily leads to process complexity, an increased number of process units, and increased thermal inefficiency. However, the inventors of the present application have discovered that by placing a pipe coil directly inside the flue gas stack above the convection section, such as within exhaust gas stack 22, and passing water through the pipe coil, a change in phase from liquid to steam can be achieved. The process may then utilize the sensible and latent heat, which is used to increase the water temperature and then change the phase from liquid to steam. The produced steam may then pass through a boiler, which is a heat source for the MED process.

As disclosed in CN105253939, more than six major pieces of equipment (economizer, electrical denitration, anti-corrosion heat exchanger, flash tank, gas liquid separator) that need to be connected between the source of flue gas and the MED process. By placing the pipe coil directly in the flue gas stack above the convection section, only one piece of equipment (i.e., flash drum) needs to be connected between the stack and the MED process.

Thus, all these method have some sort of value operational limitation, complex control intricacies, or complex thermodynamic restrictions. The prior art methods either do not form de-mineralized (DM) water or produce it in less quantity, which may not be re-used by the power plants. Also, the heat sources do not conserve energy and water.

Accordingly, one or more embodiments disclosed herein generally relate to integrated processes and systems for simultaneously recovering waste heat from crude oil refineries furnaces, or hydrocarbon refinery furnaces, and utilizing the waste heat in water desalination, saving thermal energy, minimizing thermal pollution, and increasing the overall efficiency of the plant.

Currently, the upper part of fired heaters of traditional oil refineries exhaust flue gases to the outside air. Further, multi-effect desalination (MED) is an energy intensive process and normally utilizes boilers to provide the heating requirement to operate the MED unit.

As compared to the conventional techniques for preparation of desalinated water available, which have been described above, one or more embodiments disclosed herein provide for steam generation utilizing waste flue gas of a refinery furnace or a power plant furnace in order to drive a MED process. Multi Effect Distillation (MED) in general is a known technology. Also, as compared to the conventional techniques, the process for preparation of desalinated water by waste heat from a power plant furnace, wherein, one or more embodiments disclosed herein use waste flue gas of power plant to produce steam.

Accordingly, the processes and systems according to one or more embodiments disclosed herein allow for the direct coupling of a refinery furnace with an MED process. Condensed water may be collected from the bottom of the desalination boiler and pumped through a pipe coil installed inside the upper part of the flue gas stack, above the convention section of the refinery furnace, where the temperature reaches more than 160° C., producing steam. The steam may then be fed to a flash drum to separate the vapor and non-vaporized liquid. The condensed liquid may be collected and returned to the heating coil in the stack. The vapor may then be transferred by insulated pipeline to the desalination boiler, which acts as a heating source for the MED process. The vapor may be condensed in the boiler and recycled to the heating coil in the stack for a closed loop operation.

More specifically, embodiments disclosed herein relate to an integration between the refinery and desalination plants where it can effectively enhance the efficiency of the refinery as well as reduce the operation cost of the desalination plant.

Referring again to FIG. 1, the process begins from the Multi Effect Desalination or MED plant 10. A steam stream 32 is fed to a boiler 14 of the MED plant 10. A saline stream 40, such as seawater, may be fed to a series of evaporators 42a, 42b, 42c, and into the boiler 14 to be heated against the steam stream 32. The hot saline stream 42 may then be fed back to the series of evaporators 42a, 42b, 42c as the heat source for vaporizing the saline stream 40. The evaporated portion of the saline stream 42 may be collected as desalinated vapor 44, and condensed to form desalinated water (not illustrated). Residual brine water 46 may be collected and ejected to any suitable source.

After the steam stream 32 is condensed as heat is transferred to the saline stream 40. The condensed water 12 may be collected from the bottom of the boiler 14 and boosted by a pump 16. The pressurized water 18 may then be fed through a heating coil 20 installed inside a flue gas stack 22 where the hot flue gas increases the temperature of the pressurized water to the vaporization point, vaporize the water forming steam, and increase the temperature of the steam to more than 160° C. As opposed to prior art processes that remove the flue gas from the stack and feed the gases through one or more external process units, such as external heat exchangers, combustion chambers, turbines, economizers, etc., the heating coil 20 is installed directly in the path of the flue gas within the flue gas stack 22. In such a configuration, less thermal energy is lost to additional process units and the efficiency of the integrated process may be increased.

The steam 24 may then be fed to a flash drum 26 in order to separate the vapor 28 from any non-vaporized water 30. The non-vaporized water may be collected and then returned back to the pipe coil 20 in the flue gas stack 22 for further heating, thereby producing additional steam. The steam 28 may then be fed by sufficient insulated pipeline 32 to the boiler 14 in the MED plant 10 which works as a heating source for operating the MED plant.

By collecting the condensed water 12 and the non-vaporized water 30, and recycling both of these streams to the pipe coil 20, the cycle may be a closed loop, thereby conserving water.

In one or more embodiments, where there is sufficient thermal energy transfer between the hot flue gas in the flue gas stack 22 and the pressurized water 18 to vaporize all of the pressurized water into steam, the steam may be fed directly to the MED plant boiler without the need for a flash drum. However, the process may still include a flash drum, such that the closed loop cycle may continue to operate in the event of a reduced refinery output.

Such a system may be applicable for any refinery that has a desalination system where the process can be integrated. As an example, the Ras Tanura refinery in Saudi Arabia has a desalination system which generates the refinery's utility water. The waste energy released from the refinery furnace exceeds 5 MW per stack, as measured at the outlet of the flue gas stack, while the required thermal energy to operate a boiler in a Multi-Effect Desalination system is around 1.25 MW, as measured by the amount of the thermal energy required to evaporate the saline charge stream. Therefore, it is thermodynamically possible to operate the desalination process utilizing the excess energy from the refinery stack. Moreover, the distance between the refinery furnace and the desalination plant is around 500 meters. By this range, the process between the refinery furnace and the desalination plant can be integrated and the heat can be controlled, which leads to increase the efficiency and reduce the cost of desalination operations. In further studies, it has been determined that such a closed loop system may be operable at any refinery where the waste energy from the refinery furnace stack is between 3 MW and 10 MW and the thermal energy requirement for the MED plant is 1 MW to 2 MW, and the distance between the MED boiler and the heating coil in the exhaust gas stack is less than 1000 m.

As described above, the advantage of the process disclosed herein is the integration between the refinery and MED plant which may allow for the reduction in the cost of operating the MED plant as well as increasing the efficiency of the refinery furnace by reducing the exhaust gas temperature.

Further, such an integrated system improves on the prior art processes by reducing the thermal energy losses associated with an increased number of process units (such as economizer, electrical denitration, anti-corrosion heat exchanger, multiple flash tank, multiple gas liquid separators, etc.). Further, as compared to the prior art processes which use the generated steam to drive an electric turbine, and then use the electricity to heat the water in the MED plant, the proposed process may have significantly reduced thermal energy losses.

Additionally, as the excess waste energy in a refinery's flue gas stack is often several hundred percent that of the thermal energy requirement of a typical MED plant, the size of the MED plant may be rapidly scaled if increased desalinated water is desired for use in utilities or for potable water.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. (canceled)

2. (canceled)

3. (canceled)

4. (canceled)

5. (canceled)

6. (canceled)

7. (canceled)

8. (canceled)

9. (canceled)

10. A method for desalination of salt water, the method comprising:
producing a hot flue gas in a furnace of a crude oil refinery or hydrocarbon refinery, the furnace comprising:
a radiant section;
a convention section located above the radiant section;
a flue gas stack located above the convection section;
feeding a water stream to a heating coil located in a path of the hot flue gas in the flue gas stack;
heating the water stream using the hot flue gas to convert a portion of the water to a steam stream in the heating coil;
feeding the steam stream directly to a flash drum;
separating, in the flash drum, the steam stream into a dry steam and a residual water stream;
recycling the residual water stream to the heating coil; and
feeding dry steam to a multi effect desalination plant to produce a desalinated water.

11. (canceled)

12. (canceled)

13. The method of claim 10, further comprising:
condensing the dry steam in a boiler of the multi effect desalination plant, producing a condensed steam stream;
heating a saline water in the boiler, producing a hot saline water;
producing a desalinated water from the hot saline water in one or more evaporator units of the multi effect desalination plant.

14. The method of claim 13, further comprising pumping the condensed steam stream, using a pump in fluid communication with a bottom of the boiler, to the heating coil with the residual water stream, in closed loop operation.

15. The method of claim 10, wherein the desalinated water is potable water.

16. The method of claim 13, wherein the saline water is a seawater.

17. The method of claim 10, wherein a boiler of the multi effect desalination plant is less than 1000 meters from the heating coil.

18. The method of claim 17, wherein the boiler of the multi effect desalination plant is less than 500 meters from the heating coil.

19. The method of claim 10, wherein the flue gas has a waste energy from 3 MW to 10 MW.
